(19) United States
(12) Patent Application Publication
(10) Pub. No.: US 2023/0311637 A1
(43) Pub. Date: Oct. 5, 2023

(54) HEAT EXCHANGER ASSEMBLY AS WELL AS VEHICLE COMPRISING SAID HEAT EXCHANGER ASSEMBLY

(71) Applicant: MAHLE Behr GmbH & Co. KG, Stuttgart (DE)

(72) Inventors: Reinhard Heine, Leutenbach (DE); Dieter Schweidler, Vaihingen (DE)

(21) Appl. No.: 18/122,281

(22) Filed: Mar. 16, 2023

(30) Foreign Application Priority Data
Mar. 16, 2022 (DE) 10 2022 202 610.1

(51) Int. Cl. B60K 11/04

(52) U.S. Cl. CPC B60K 11/04

(57) ABSTRACT

The present invention relates to a heat exchanger assembly (1) for a vehicle (2), having a heat exchanger (3) and two lateral enclosures (4, 5), which hold the heat exchanger (3) and which are arranged on opposite sides (7) of the heat exchanger (3) in order to each enclose a section (9) of a circumferential edge (8) of the heat exchanger (3). The lateral enclosures (4, 5) each have a first plug-in part (11), which is fixed in a positive manner to the heat exchanger (3), a second plug-in part (12), which is likewise fixed in a positive manner to the heat exchanger (3), as well as a fixing part (13), which is arranged on the first plug-in part (11) and/or on the second plug-in part (12), for fixing the respective lateral enclosure (4, 5) to the structural component (10). It is essential that the first plug-in parts (11) can be locked or are locked in a positive manner with the second plug-in parts (12). The invention relates in particular to a vehicle (2) comprising at least one such heat exchanger assembly (1).

The invention relates to a heat exchanger assembly for a vehicle according to the preamble of claim 1. The invention relates in particular to a vehicle comprising at least one such heat exchanger assembly.

Heat exchanger assemblies of the above-mentioned type are described, for example, in U.S. Pat. No. 10,274,267 B1, DE 10 2018 116 452 A1, and DE 10 2009 031 695 A1. They generally have a heat exchanger as well as a holder for fixing or holding, which is to be understood synonymously hereinafter, said heat exchanger to a structural component of a vehicle. The known holders are of relatively large construction and often completely enclose the entire circumferential edge of a heat exchanger, so that they are complex, in particular from a structural point of view, and thus have to be installed on the heat exchanger as well as on the structural component with much effort. The manufacture and installation of the known heat exchanger assemblies thus becomes relatively time- and cost-intensive, even though more cost-efficient solutions are desired for in order to increase the competitiveness.

It is thus the object of the invention to specify an improved or at least another embodiment for a heat exchanger assembly. A vehicle comprising at least one such heat exchanger assembly is to in particular also be provided.

In the case of the present invention, this object is solved in particular by means of the subject matters of the independent claims. Advantageous embodiments are subject matter of the dependent claims and of the description.

It is the basic idea of the invention to replace the holders, which are being used in the case of such a heat exchanger assembly for holding (or fixing) the heat exchanger with two separate, quasi modularly constructed lateral enclosures, the components of which, which will be referred to hereinafter as plug-in parts and fixing parts, are manufactured cost-efficiently, can be fixed relatively easily and quickly to a heat exchanger as well as to a structural component of a vehicle.

According to this, a heat exchanger assembly for a vehicle is provided, which has a heat exchanger, which is preferably produced in an all-aluminum construction, for example a coolant radiator or a condenser, and two separate lateral enclosures, which are in particular not directly cohesive and which hold (or fix) the heat exchanger. The lateral enclosures are arranged on sides of the heat exchanger, which are opposite to one another, in particular in a main direction referred to as X direction, in particular on short or long sides of the heat exchanger, which are aligned horizontally or vertically with respect to a ground, on which the vehicle is parked and which each enclose a section of a circumferential edge of the heat exchanger, and they are configured to jointly hold or to fix the heat exchanger assembly on a structural component of the vehicle. According to the invention, the lateral enclosures thereby each have a first, in particular separate plug-in part, which is fixed in a positive manner to the heat exchanger, a second, in particular separate plug-in part, which is fixed in a positive manner to the heat exchanger, as well as an in particular separate fixing part, which is arranged on the first plug-in part and/or on the second plug-in part, for fixing the respective lateral enclosure to the structural component. The lateral enclosures are thus in particular constructed in a quasi-modular manner. In the installed state of the heat exchanger assembly, the first plug-in parts and/or second plug-in parts are advantageously attached to the heat exchanger. It is furthermore essential that the first plug-in parts can be locked or are locked in a positive manner with the second plug-in parts. Compared to conventional solutions for holding heat exchangers, in the case of which in particular frames are used, which are of relatively large construction and which enclose the heat exchanger all around, the lateral enclosures proposed by the invention for holding the heat exchanger can be provided cost-efficiently in large quantities, are relatively compact, lightweight, and can be installed easily and quickly. This is attained in particular in that the plug-in parts and fixing parts, which are used to form the lateral enclosures, are structurally not very complex, and the plug-in parts are fixed to the heat exchanger by means of a positive connection, so that in particular no additional aids, such as, for example, adhesives or fastening screws, are required for installing the plug-in parts on the heat exchanger, wherein these positive connections can be designed in a detachable or non-detachable manner. This is further also attained in that the plug-in parts of a lateral enclosure can be locked or are locked easily and quickly with one another in a positive manner, for example by means of a clip connection (also locking connection), which forms a positive connection, which provides for the installation of the proposed heat exchanger assembly in particular manually by hand. Said positive connections can also be designed in a detachable or non-detachable manner. Plug-in parts and fixing parts are, for example, plastic parts or plastic composite material parts, whereby a cost-efficient and lightweight realization of the heat exchanger assembly is possible.

In terms of the invention, the expression “enclosing” can advantageously mean that the lateral enclosures encompass the heat exchanger, in particular engaging in a u-shaped manner. In terms of the invention, the term “holding” can advantageously be used like “fixing”. The heat exchanger, which is enclosed to be held by the lateral enclosures, is in particular held so that the heat exchanger fixes relative to the lateral enclosures, is thus immobile.

It is advantageous when the first plug-in parts and/or the second plug-in parts of the lateral enclosures are fixed in a positive manner to the heat exchanger by means of caulking with the heat exchanger. In particular at least one positive connection can or will be realized thereby, which is formed between and/or on the respective first plug-in part and/or the respective second plug-in part and the heat exchanger by means of caulking a first plug-in part and/or a second plug-in part of the lateral enclosures with the heat exchanger. The respective positive connection can thereby be characterized in that the respective first plug-in part, which is made of softer material with respect to the heat exchanger and/or the respective second plug-in part, which is made of softer material with respect to the heat exchanger, is cut and/or partially peeled and/or plastically deformed by means of the heat exchanger, which is made of harder material, whereby the respective first plug-in part and/or the respective second plug-in part wedges in a positive manner with the heat exchanger detachably or non-detachably as well as without play. A preferred positive connection for the first plug-in parts and/or the second plug-in parts with the heat exchanger is thus specified. This has the advantage that said first and second plug-in parts and the heat exchanger can be fixed to one another cost-efficiently, in particular without additional fastening means, such as, for example, adhesives or fastening screws. This positive connection can be designed in a detachable or non-detachable manner. This positive connection of said plug-in parts to the heat exchanger additionally allows for the use of different materials, for example a plastic-aluminum material pairing is conceivable, so that the heat exchanger assembly can be optimized in particular with regard to its weight as well as the manufacturing costs.

It is thereby advantageously easy to understand for the person of skill in the art that the expressions “made of softer material” and “made of harder material” refer to the respective material hardnesses of the used materials of the first and/or second plug-in parts or of the heat exchanger, respectively. The person of skill in the art can determine a respective material hardness, for example, by means of a generally known hardness testing method, for example according to Rockwell.

The invention advantageously understands the term “caulking” to be a joining process, in the case of which a positive connection is or will be realized by means of caulking two joining partners and which is characterized in that the one joining partner, which is made of softer material, for example said plug-in parts, is cut and/or partially peeled and/or plastically deformed by the joining partner, which is made of harder material, for example the heat exchanger, whereby the two joining partners are wedged together in a positive manner detachably or non-detachably as well as without play. It could thus also be defined that by means of caulking with the heat exchanger, the first plug-in parts and/or the second plug-in parts form a caulking or positive connection with said heat exchanger, within which the first plug-in parts and/or the second plug-in parts are wedged together in a positive manner releasably or non-releasably as well as without play with the heat exchanger, whereby the first plug-in parts and/or the second plug-in parts are fixed in a positive manner detachably or non-detachably and without play to the heat exchanger.

It is further advantageous when the lateral enclosures are each of U-shaped design. It can in particular also be provided that the first plug-in parts and/or the second plug-in parts of the lateral enclosures are each of L-shaped design. Preferred embodiments for the lateral enclosures or for the first plug-in parts and/or second plug-in parts of the lateral enclosures, respectively, are thus specified, by means of which in particular a rectangularly designed heat exchanger can be enclosed relatively well.

It can furthermore be provided that the first plug-in parts and/or the second plug-in parts of the lateral enclosures each have two legs, which are perpendicular to one another, each comprising a u-shaped leg cross section profile. It is advantageous when the two legs of a first plug-in part and/or the two legs of a second plug-in part form or limit a leg plug-in receptacle, which is limited by the respective u-shaped leg cross section profile, wherein the leg plug-in receptacles of the two legs of a first plug-in part and/or of a second plug-in part optionally limit or form a common, cohesive plug-in part plug-in receptacle of the first plug-in part and/or of the second plug-in part for immersion of the heat exchanger, so that the first plug-in parts and/or the second plug-in parts can be attached to the heat exchanger or are attached to the heat exchanger in the installed state of the heat exchanger assembly. A further preferred embodiment is thus specified for the first and second plug-in parts. The two legs of a first and/or second plug-in part each also form or limit a plug-in receptacle opening, which is predetermined by the respective u-shaped leg cross section profile and through which one can engage with the respective leg plug-in receptacle or the plug-in part plug-in receptacle, respectively.

It can advantageously be provided that in the installed state of the heat exchanger assembly, the first plug-in parts and/or the second plug-in parts are attached to the heat exchanger, wherein the heat exchanger is immersed into said plug-in part plug-in receptacles of the first plug-in parts and/or of the second plug-in parts and abuts with contact and in particular in a fluid-tight manner on the legs of the first plug-in parts and/or of the second plug-in parts. A sealing means can thereby advantageously be interconnected.

At least one first plug-in part and/or at least one second plug-in part of the lateral enclosures can in particular have support ribs for supporting the heat exchanger. The support ribs are thereby advantageously arranged on one leg of the two legs or on both legs of the respective first plug-in part and/or of the respective second plug-in part within the respective leg plug-in receptacle and are integrally connected to the respective leg. In each case starting at the respective leg, the support ribs advantageously protrude into the plug-in receptacle, so that the heat exchanger, which is completely inserted through, for example, a respective plug-in receptacle opening, can support on these support ribs with contact. Said support ribs are further advantageously arranged in pairs and so as to run parallel to one another within the leg plug-in receptacle on a leg wall, which is located opposite the respective plug-in receptacle opening, of the respective leg.

It can advantageously be provided that at least a first plug-in part and/or at least a second plug-in part of the lateral enclosures has positive ribs for forming a positive connection, which is or will be formed between and/or on the respective first plug-in part and/or the respective second plug-in part and the heat exchanger by means of caulking the respective first plug-in part and/or the respective second plug-in part with the heat exchanger. It can furthermore be provided that said positive ribs are arranged on at least one said leg of the two legs or on both said legs of the respective first plug-in part and/or of the respective second plug-in part within the respective leg plug-in receptacle, and are integrally connected to the respective leg, and protrude into the respective leg plug-in receptacle. The positive ribs can furthermore be configured to be cut and/or peeled and/or plastically deformed by means of the heat exchanger when attaching a respective plug-in part onto the heat exchanger, whereby the first plug-in part and/or the second plug-in part are wedged on the heat exchanger detachably or non-detachably as well as without play. A preferred embodiment is thus specified, by means of which a positive connection between a first plug-in part and/or a second plug-in part and the heat exchanger is optimized.

To make the first and second plug-in parts, which are mechanically stressed in particular by their installation on the heat exchanger and/or handling, such as transport and storage, resistant, it can advantageously be provided that the first and second plug-in parts are each equipped with support struts, which connect the legs of the respective plug-in parts to one another, so that a mutual support of the legs and thus a reinforcement of the first and second plug-in part is attained. The support struts can thereby each be integrally connected to the legs. They can reach, for example, from one leg end of the one leg to the middle of the other leg of the respective first plug-in part and/or second plug-in part.

It is advantageous when the two lateral enclosures combined do not enclose the complete circumferential edge of the heat exchanger. In other words, the two lateral enclosures each only enclose a section of the circumferential edge of the heat exchanger, which is smaller than the complete circumferential edge of the heat exchanger. The circumferential edge of the heat exchanger can advantageously be formed by means of cohesive narrow surfaces of the heat exchanger. It can furthermore be provided that the two lateral enclosures combined enclose at least 25% of the circumferential edge of the heat exchanger, and/or that the two lateral enclosures combined maximally enclose 50% of the circumferential edge of the heat exchanger. It can also be provided that the lateral enclosures each completely enclose a section of the heat exchanger, which is aligned vertically with respect to a ground, on which the vehicle is parked, in particular a vertical narrow short surface of the heat exchanger, as well as each enclose at least 10% and maximally 20% of two sections, which are aligned horizontally with respect to the ground and which are arranged parallel to one another, in particular each a horizontal narrow long surface of the heat exchanger. A preferred design for the two lateral enclosures is thus specified.

In order to lock a first plug-in part in a positive manner with a second plug-in part, it can advantageously be provided that a pair of locking protrusions is arranged on the first plug-in part, and a pair of locking receptacles, which is formed complementary with respect to said locking protrusions, is arranged on the second plug-in part, or vice versa. Locking protrusions and locking receptacles can be locked or are locked with one another and form a first clip connection for connecting the first plug-in parts in a positive manner to the second plug-in parts. It is furthermore advantageous when, in the installed state of the heat exchanger assembly, at least one pair of locking protrusions is locked into position with a pair of locking receptacles. A positive locking, which is simple from a structural aspect, of a first plug-in part with a second plug-in part can thus be provided.

The first clip connection advantageously forms a locking connection, wherein the locking protrusions and the complementary locking receptacles are configured to form a positive, detachable or non-detachable connection by inserting and locking the locking protrusions into position with the locking receptacles. In particular the use of additional connecting means, such as, for example, adhesives or fastening screws, can thus be forgone.

During the installation of the heat exchanger assembly, a pair of locking protrusions is advantageously inserted into a complementary pair of locking receptacles in a joining direction, wherein locking lugs, which are integrally arranged on the respective locking protrusions and which protrude away from the respective locking protrusions, lock into position with a respective locking receptacle, so that said first clip connection is locked, and a removal of the locking protrusions from the locking receptacles opposite to the joining direction is blocked. The first clip connection can advantageously be unlocked by means of, for example, manual actuation.

It is advantageous when the lateral enclosures or the first plug-in parts and/or the second plug-in parts are arranged in a fluid-tight manner on the heat exchanger. The first plug-in parts and/or the second plug-in parts can advantageously have a sealing means, which is connected between the respective first plug-in part or the respective second plug-in part and the heat exchanger. Said plug-in parts are thus in each case equipped with a sealing function, so that fluid, for example, cannot unintentionally flow through between the respective plug-in part or the respective lateral enclosure, respectively, and the heat exchanger.

It can furthermore be provided that a passage for a connecting piece of the heat exchanger is limited or formed at least between a first plug-in part and a second plug-in part of a lateral enclosure. It can be provided thereby that said passage passes through a first clip connection of the respective lateral enclosure and/or that said passage is flanked on both sides by locking protrusions and locking receptacles of the respective lateral enclosure. An embodiment is thus specified for the lateral enclosures, which also takes into consideration connecting pieces of the heat exchanger. The lateral enclosures can thus be used flexibly.

It can advantageously be provided that the lateral enclosures or the first plug-in parts and/or the second plug-in parts and/or the fixing parts are made of:
a plastic or a plastic composite material, or
a plastic, for example polypropylene (PP) or polyamide (PA), without glass fiber content, or
a plastic, for example polypropylene (PP) or polyamide (PA), with a glass fiber content, or
that the first plug-in parts are made of polyamide (PA) with glass fiber content, and the second plug-in parts of polypropylene (PP) with glass fiber content, or
that the first plug-in parts are made of polypropylene (PP) with glass fiber content, and the second plug-in parts of polyamide (PA) with glass fiber content, and/or
that the lateral enclosures or the first plug-in parts and/or the second plug-in parts and/or the fixing parts are realized as hard or soft parts.

Preferred embodiments for plug-in parts are thus specified, which are characterized in particular by a low dead weight and a relatively high mechanical strength.

It can in particular be provided that the first and second plug-in parts are each realized as monolithic components, they can be realized, for example, as injection molded parts.

It can advantageously be provided that the first plug-in parts or the second plug-in parts have an interface, which is referred to as second clip connection, by means of which the fixing part of a lateral enclosure and the respective first plug-in part or the respective second plug-in part can be locked or are locked with one another in a positive manner. The second clip connection can advantageously be equipped with a retaining means for the fixing part, which does allow for a mobility of the fixing part relative to the first plug-in part or second plug-in part, but which prevents a complete detaching from the first plug-in part or second plug-in part. The fixing part can thus not accidentally get lost, for example when it is pre-installed on the first plug-in part or second plug-in part on the supplier-side. The retaining means can be realized in particular by means of a ramp, which is arranged on the first plug-in part or second plug-in part and which is oriented at an angle with respect to the main extension of the first plug-in part or of the second plug-in part. Two mirror-symmetrical ramps, which are arranged on opposite sides of the first plug-in part or second plug-in part, are advantageously provided on the first plug-in part or second plug-in part. The fixing part can cooperate with the ramp or the two mirror-symmetrical ramps, respectively, wherein it is initially clipped onto the ramp or ramps, respectively, in an initial position. In the initial position, the fixing part is movably and captively secured on the first plug-in part or on the second plug-in part. The fixing part can be adjusted from the initial position into a fixing position, for example manually by hand. The fixing part thereby glides along the ramp or the two ramps, respectively, until it reaches a fixing position, in which the fixing part is jammed without play to the first plug-in part or the second plug-in part by means of the ramp or ramps, respectively.

Advantageously, the fixing part per se is a monolithic body, in particular on one end comprising a locking means for the clip-on and locking of the fixing part with an interface of a first plug-in part or of a second plug-in part, in particular the said second clip connection or a fixing part receptacle of a plug-in part, as well as, on the other end comprising a structural part interface for fixing the fixing part to the vehicle. The fixing part can furthermore be equipped with a catch lock, which secures the fixing part in said fixing position against unintentional actuation, a locking connection can advantageously be used, for example by means of a locking window arranged on the fixing part, and a locking lug, which is formed in a complementary manner and which is arranged on the first plug-in part or on the second plug-in part, or vice versa. The installation of the heat exchanger assembly can be simplified by means of the separate fixing part.

It can advantageously also be provided that the fixing parts are each arranged on a section, which is aligned vertically with respect to a ground, on which the vehicle is parked, of the first plug-in part and/or of the second plug-in part. In the installed state of the heat exchanger assembly, the fixing parts are thus quasi arranged laterally on the heat exchanger.

It can further advantageously be provided that the fixing parts are each arranged on a section, which is aligned horizontally with respect to a ground, on which the vehicle is parked, of the first plug-in part and/or of the second plug-in part. In the installed state of the heat exchanger assembly, the fixing parts are thus quasi arranged on the top or on the bottom of the heat exchanger.

It can furthermore be provided that the first plug-in parts are realized by means of identical parts or that the second plug-in parts are realized by means of identical parts. Alternatively, the first plug-in parts and the second plug-in parts can also be realized by means of identical parts. The first plug-in parts and/or the second plug-in parts can thus be provided relatively cost-efficiently.

It can advantageously be provided that the first plug-in parts and/or the second plug-in parts are equipped with additional functional parts, for example clipped-in or screwed-on or welded-on holders for additional functional components and/or electrical lines and/or fluidic lines or uncoupling elements. The first plug-in parts and/or the second plug-in part can furthermore be equipped with an internal spring element, which is in each case elastically tensioned onto the heat exchanger. The first plug-in parts and/or the second plug-in parts, thus quasi the lateral enclosures, can thus be equipped with additional functions.

It can furthermore be provided that at least one in particular metallic holder is soldered to the heat exchanger, by means of which at least one lateral enclosure can be fixed or is fixed to the heat exchanger. The lateral enclosures can additionally be fixed to the heat exchanger by means of the holding means. With their help, for example the positive connection between lateral enclosures and heat exchanger can be supported.

According to a further basic idea of the invention, it is provided to install at least one above-described heat exchanger assembly into a vehicle. For this purpose, a vehicle is proposed, which is equipped with at least one installed heat exchanger assembly according to the preceding description, the heat exchanger of which is realized by means of a coolant radiator or a condenser. The at least one heat exchanger assembly is fixed to a structural component of the vehicle by means of its two lateral enclosures. An advantageous vehicle comprising at least one heat exchanger assembly is thus specified.

It can also be provided that the locking of the plug-in parts by means of their locking protrusions and locking receptacles takes place simultaneously or as part of an operating step with the described caulking of the plug-in parts with the heat exchanger for realizing a positive connection.

In summary, it is important to note: The present invention advantageously relates to a heat exchanger assembly for a vehicle, having a heat exchanger and two lateral enclosures, which hold the heat exchanger and which are arranged on opposite sides of the heat exchanger in order to each enclose a section of a circumferential edge of the heat exchanger. The lateral enclosures each have a first plug-in part, which is fixed in a positive manner to the heat exchanger, a second plug-in part, which is likewise fixed in a positive manner to the heat exchanger, as well as a fixing part, which is arranged on the first plug-in part and/or on the second plug-in part, for fixing the respective lateral enclosure to the structural component. It is essential that the first plug-in parts can be locked or are locked in a positive manner with the second plug-in parts. The invention relates in particular to a vehicle comprising at least one such heat exchanger assembly.

Further important features and advantages of the invention follow from the subclaims, from the drawings, and from the corresponding figure description on the basis of the drawings.

It goes without saying that the above-mentioned features and the features, which will be described below, cannot only be used in the respective specified combination, but also in other combinations or alone, without leaving the scope of the present invention.

Preferred embodiments of the invention are illustrated in the drawings and will be described in more detail in the following description, whereby identical reference numerals refer to identical or similar or functionally identical components.

In Each Case Schematically,

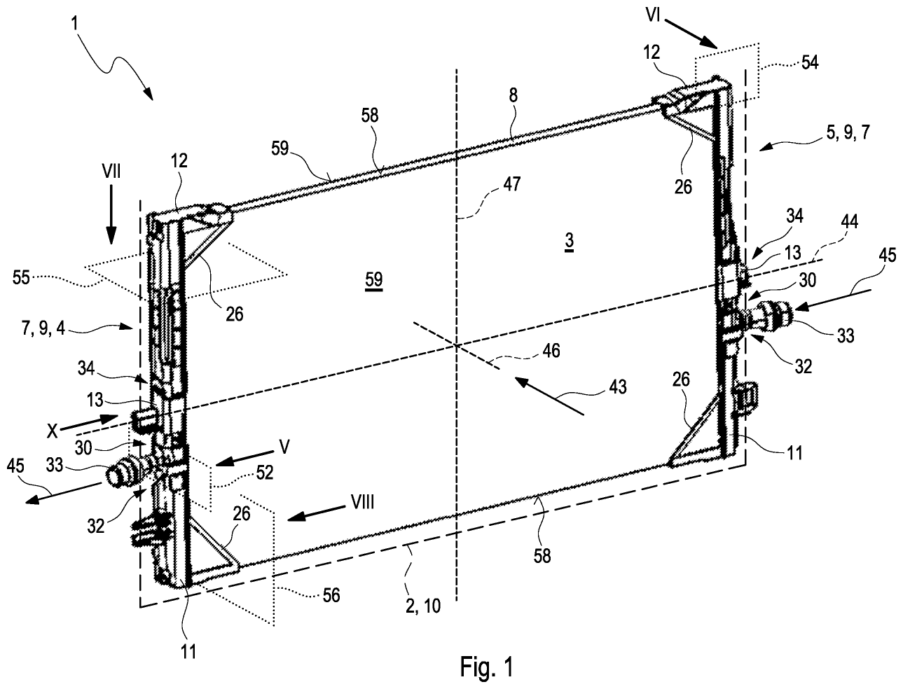

FIG. 1 shows a perspective view of a heat exchanger assembly according to a preferred embodiment,

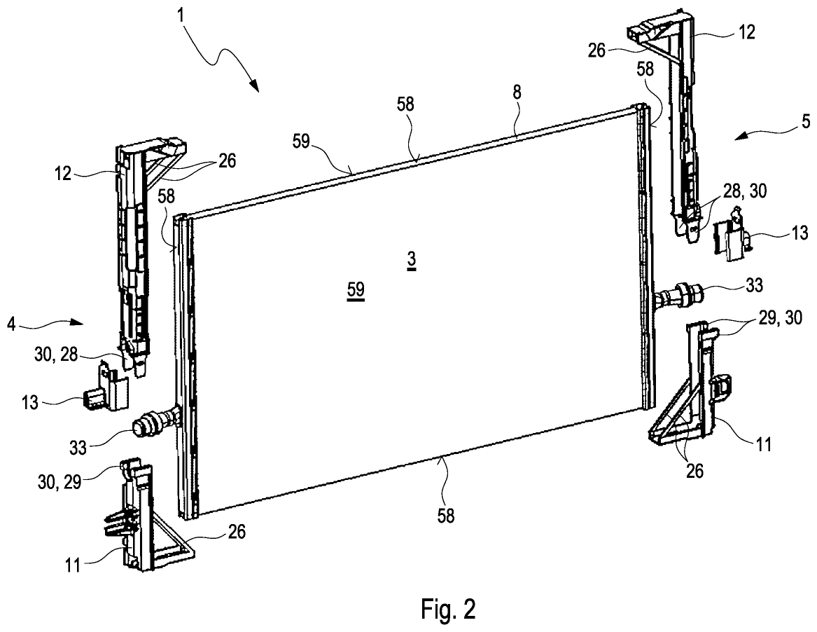

FIG. 2 shows the heat exchanger assembly from FIG. 1 in an exploded perspective view,

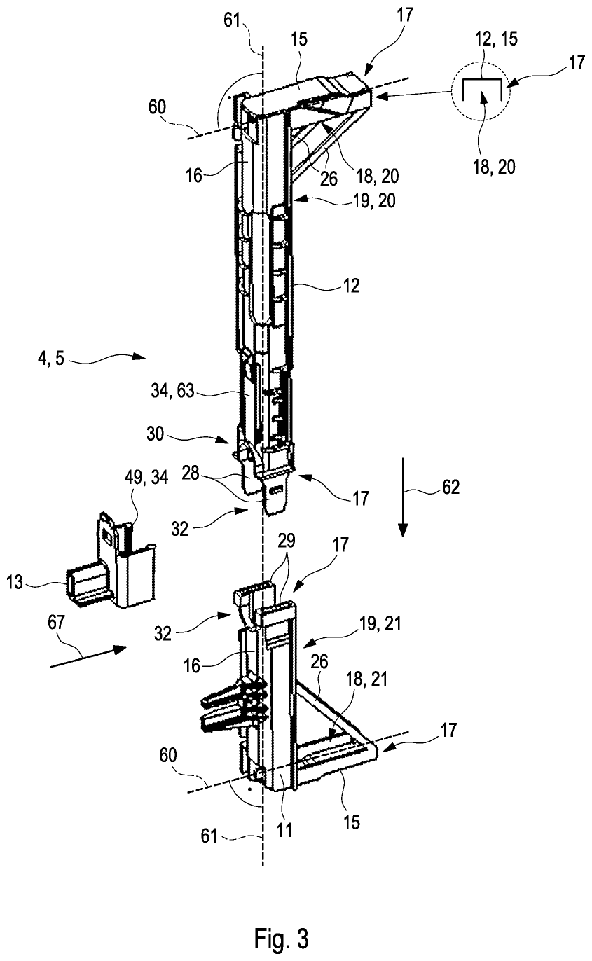

FIG. 3 shows an individual lateral enclosure of the heat exchanger assembly from FIG. 1 in an exploded perspective view,

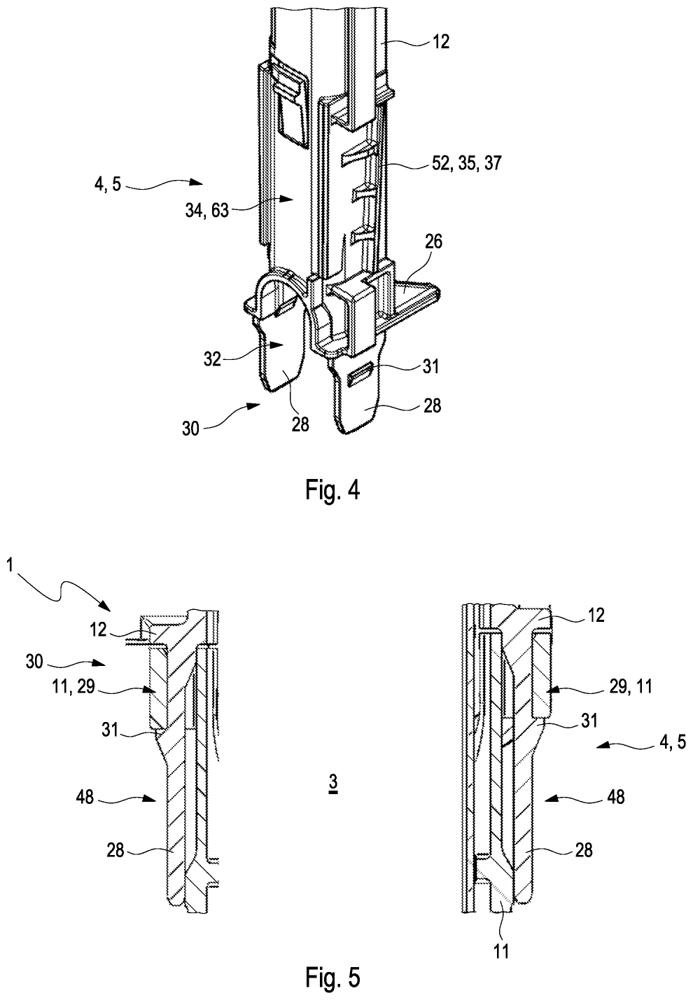

FIG. 4 shows a section of the lateral enclosure from FIG. 3 but according to a slightly modified alternative,

FIG. 5 shows a sectional view of the heat exchanger assembly from FIG. 1 according to a plane entered by means of a dashed line in FIG. 1 with a view in the direction of an arrow V, which is likewise entered there,

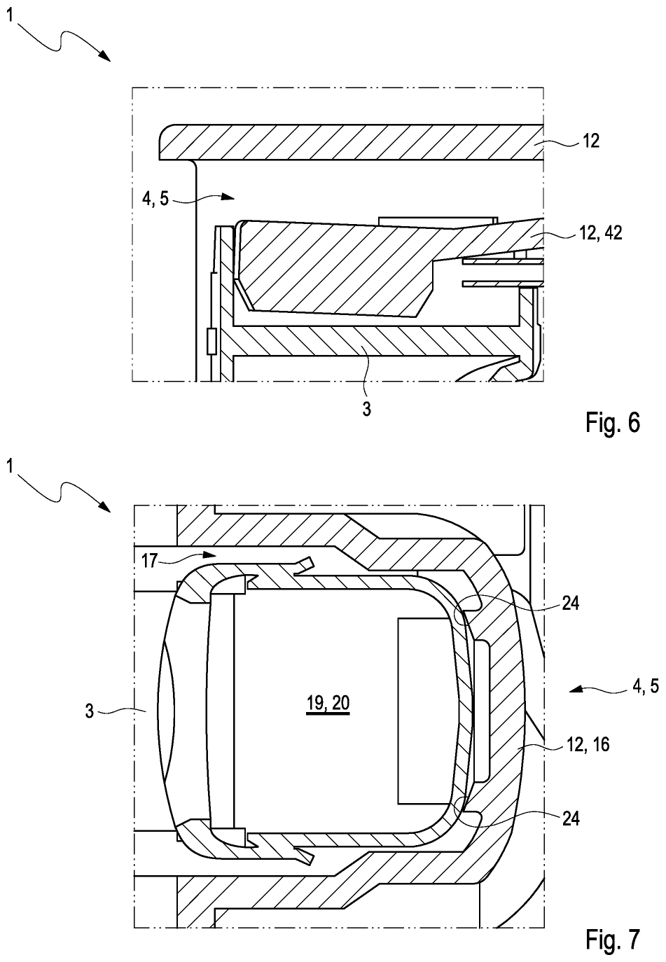

FIG. 6 shows a sectional view of the heat exchanger assembly from FIG. 1 according to a plane entered by means of a dashed line in FIG. 1 with a view in the direction of an arrow VI, which is likewise entered there,

FIG. 7 shows a sectional view of the heat exchanger assembly from FIG. 1 according to a plane entered by means of a dashed line in FIG. 1 with a view in the direction of an arrow VII, which is likewise entered there,

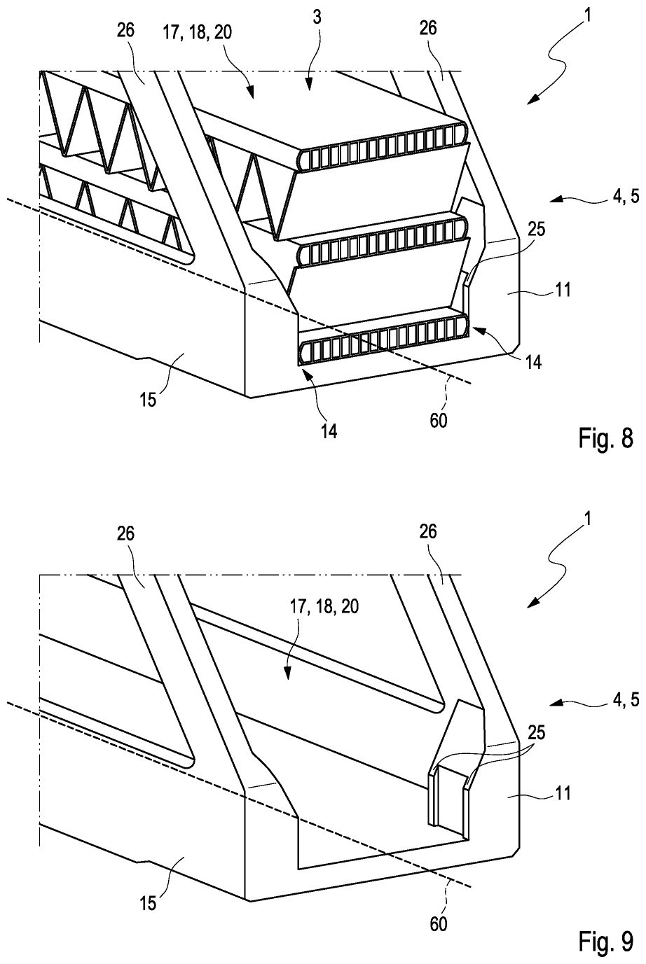

FIG. 8 shows a sectional view of the heat exchanger assembly from FIG. 1 according to a plane entered by means of a dashed line in FIG. 1 with a view in the direction of an arrow VIII, which is likewise entered there,

FIG. 9 shows a sectional view of the heat exchanger assembly from FIG. 1 according to a plane entered by means of a dashed line in FIG. 1 with a view in the direction of an arrow VIII, which is likewise entered there, but the heat exchanger is hidden,

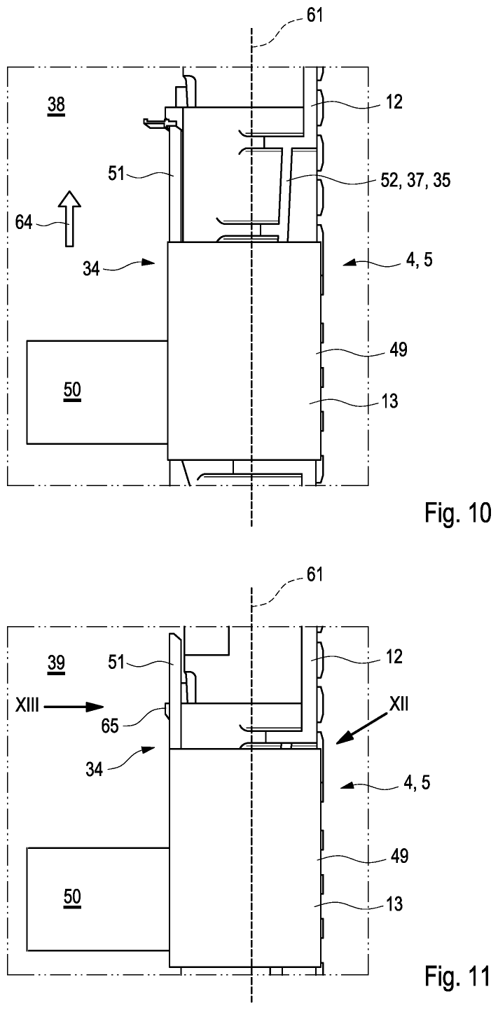

FIG. 10 shows, in a side view, a section of the heat exchanger assembly from FIG. 1 with a view in the direction of an arrow X, which is entered there, whereby the visible fixing part of the lateral enclosure is actuated into its initial position,

FIG. 11 shows, in a further side view, a section of the heat exchanger assembly from FIG. 1 with a view in the direction of the arrow X, which is entered there, whereby the visible fixing part of the lateral enclosure is now actuated into its fixing position,

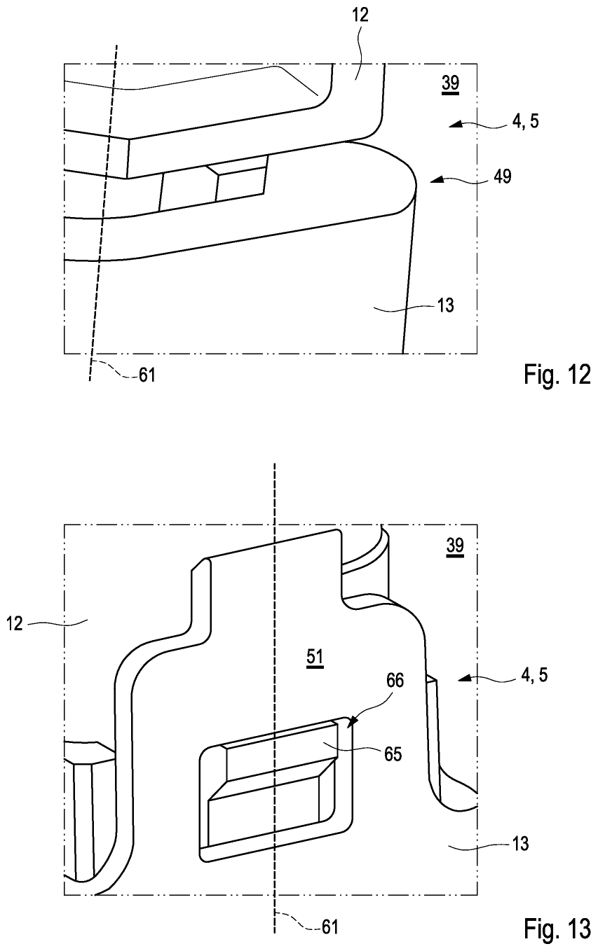

FIG. 12 shows the fixing part from FIG. 11 in a perspective view according to an arrow XII drawn in there, and lastly

FIG. 13 shows the fixing part from 11 in a further perspective view, but now according to an arrow XIII, which is drawn in there.

FIG. 1 shows a heat exchanger assembly, which, in its entirety, is identified with reference numeral 1, for a vehicle 2, which is suggested only in FIG. 1 and only symbolically. The heat exchanger assembly 1, which can be provided as bought-in product in the configuration illustrated in FIG. 1, has a heat exchanger 3, which is produced, for example, in an all-aluminum construction and which can realize a coolant radiator of the vehicle 2 or a condenser of the vehicle 2. As an example, the heat exchanger 3 is of conventional construction, of rectangular design as a whole, comprising four cohesive narrow surfaces 58 forming a circumferential edge 8 of the heat exchanger 3, two opposite large surfaces 59, as well as comprising two connecting pieces 33 for cooling liquid, see FIGS. 1 and 2. According to its function, the heat exchanger 3 is flown through in a main direction, which is referred to as Y direction 46 and which is orthogonal to said large surfaces 59, by a cooling air flow 43 of cooling air, which is suggested in FIG. 1 by means of a simple arrow, and, further according to its function, is flown through longitudinally in a further main direction, which is referred to as X direction 44 and which is perpendicular to the Y direction 46, by a liquid flow 45 of cooling liquid, which is suggested in FIG. 1 by two further arrows positioned on said connecting pieces 33, so that the cooling air flow 43 and the liquid flow 45 cross one another. Heat energy can thus be transferred relatively easily from the liquid to the cooling air, or vice versa. A Z direction 47, which is perpendicular with respect to the X direction 44 and the Y direction 46, is furthermore also entered in FIG. 1.

In addition to the heat exchanger 3, the heat exchanger assembly 1 has two separate lateral enclosures 4, 5, which are designed in an approximately u-shaped manner and which are arranged on the heat exchanger 3 on sides 7 of the heat exchanger 3, which are opposite one another in the X direction 44, in particular in sections on said narrow surfaces 58, and which each extend in the Y direction 46, which could be referred to as main extension of the lateral enclosures 4, 5. They each enclose a section 9 of the circumferential edge 8 of the heat exchanger 3, one could also say they encompass the heat exchanger 3 in sections in such a way that the latter is held firmly. The heat exchanger 3 is thus completely immobile with respect to the lateral enclosures 4, 5. Viewed with respect to its length, a respective section 9 is smaller than the circumferential edge 8 of the heat exchanger 3. For example, its respective dimension, i.e. advantageously its length, is less than 50% of the dimension of the circumferential edge 8, its respective dimension is further for example more than 25% of the dimension of the circumferential edge 8. The lateral enclosures 4, 5 are configured to jointly fix the heat exchanger assembly 1 detachably or non-detachably to a structural component 10 of the vehicle 2, which, for reasons of simplicity, is suggested only by means of a symbolic, dashed line in FIG. 1.

In an exemplary manner, the lateral enclosures 4, 5 are constructed modularly of a first, separate plug-in part 11, which is fixed in a positive manner to the heat exchanger 3, a second separate plug-in part 12, which is likewise fixed in a positive manner to the heat exchanger 3, as well as a separate fixing part 13, which is arranged in an exemplary manner on the second plug-in part 12 and which serves the purpose of fixing the respective lateral enclosures 4, 5 to said structural component 10. The first plug-in parts 11 and the second plug-in parts 12 are each of approximately L-shaped design. The first plug-in parts 11 are realized as identical parts herein. The second plug-in parts 12 as well as the fixing parts 13 are also realized as identical parts herein.

FIG. 2 shows the heat exchanger assembly 1 from FIG. 1 in a perspective exploded view, so that the above-mentioned components of the heat exchanger assembly 1 or of the lateral enclosures 4, 5, respectively, can be recognized more easily. To describe the details, one lateral enclosure 4 of the lateral enclosures 4, 5 illustrated in FIGS. 1 and 2, is selected, and is illustrated in FIG. 3 in a perspective exploded view, wherein the following descriptions analogously also refer to the other lateral enclosure 5, which is not illustrated in FIG. 3.

It can be seen in FIG. 3 that the first plug-in part 11 and the second plug-in part 12 each has two legs 15, 16, which each define a secondary axis 60 or 61, respectively, which is in each case suggested in a dashed manner, and which are perpendicular to one another with respect to these secondary axes 60, 61. The secondary axes 60, 61 can be considered to be main extensions of the legs 15, 16. Said legs 15, 16 each have a u-shaped leg cross section profile 17, which is illustrated symbolically in a framed detail view, which is additionally added in FIG. 3 and which shows a view onto the one leg 16 with a view in the direction of a secondary axis 60, 61, and which can also be seen for the other leg 15 in FIG. 7. The legs 15, 16 are thereby connected to one another on their leg ends and can, if it is advantageous, be provided as a monolithic structural unit, so that, in practice, they can be manufactured cost-efficiently, for example as part of an injection molding process. The two legs 15, 16 of the first plug-in part 11 as well as the two legs 15, 16 of the second plug-in part 12 each have a leg plug-in receptacle 18 or 19, respectively, which is limited or formed by means of the respective u-shaped leg cross section profile 17. The two leg plug-in receptacles 18, 19 of the first plug-in part 11 and of the second plug-in part 12, in turn, form a common, cohesive plug-in part plug-in receptacle 20 or 21, respectively, of the respective plug-in part 11, 12, into which the heat exchanger 3 can immerse. It is thus possible that the first plug-in parts 11 and the second plug-in parts 12 are attached to the heat exchanger 3 in the course of the installation of the heat exchanger assembly 1, and are then attached in a positive manner to the heat exchanger 3 in the installed state of the heat exchanger assembly 1.

To establish said positive connections between the plug-in parts 11, 12 and the heat exchanger 3, it is provided that the first plug-in parts 11 and the second plug-in parts 12 are each attached to the heat exchanger 3, in the Z direction 47 herein, wherein the first plug-in parts 11 and the second plug-in parts 12 are or will be fixed in a positive manner to the heat exchanger 3 by means of caulking with the heat exchanger 3. By means of the caulking, at least one positive connection 14 is provided on the heat exchanger assembly 1, which could also be referred to as caulking connection. In any event, the respective positive connection 14 is characterized in that the respective first plug-in part 11, which is made of softer material with respect to the heat exchanger 3 and the respective second plug-in part 12, which is likewise made of softer material with respect to the heat exchanger 3, is cut and/or partially peeled and/or plastically deformed by means of the heat exchanger 3, which is made of harder material and which is produced in all-aluminum construction, as mentioned above. As a result, said plug-in parts 11, 12 wedge or jam with the heat exchanger 3. The respective first plug-in part 11 and the respective second plug-in part 12 are thus held or fixed in a positive manner with the heat exchanger 3 detachably or non-detachably as well as without play with respect to the X direction 44, the Y direction 46, as well as the Z direction 47.

To make the first and second plug-in parts 11, 12, which are mechanically stressed in particular by their installation on the heat exchanger 3 and/or handling, such as transport and storage, resistant, the first and second plug-in parts 11, 12 are each equipped with support struts 26. They mutually reinforce the legs 15, 16 or realize a mutual support, respectively, see in particular FIGS. 1 and 3.

FIG. 8 shows a sectional view of the heat exchanger assembly 1 from FIG. 1 according to a plane entered in by means of a dashed line FIG. 1 with a view in the direction of an arrow VIII, which is likewise entered there. FIG. 9 shows, very similarly, a sectional view of the heat exchanger assembly from FIG. 1 according to a plane entered by means of a dashed line in FIG. 1 with a view in the direction of an arrow VIII, which is likewise entered there, but the heat exchanger 3 is hidden. In order to be able to optimize or realize the mentioned positive connection between the first plug-in parts 11 and the heat exchanger 3 as well as between the second plug-in parts 12 and the heat exchanger 3, it is provided in an exemplary manner that the first plug-in parts 11 and the second plug-in parts 12 are each equipped with positive ribs 25, see FIG. 9. They are configured to form a said positive connection 14 with the heat exchanger 3. The positive ribs 25 are provided in an exemplary manner on one leg 15 of the two legs 15, 16 of the respective first plug-in part 11, whereby they are arranged within the respective leg plug-in receptacle 18 and are connected integrally to the respective leg 15. As can be seen in FIG. 9, the positive ribs 25 protrude into the leg plug-in receptacle 18, 20, so that the heat exchanger 3 cuts into the positive ribs 25 and/or peels them and/or plastically deforms them when attaching the respective plug-in part 11 to the heat exchanger 3, whereby the first plug-in part 11 is wedged or jammed in a positive manner releasably or non-releasably as well as without play with respect to the X direction 44, the Y direction 46, as well as the Z direction 47. It goes without saying that positive ribs 25 of this type can also be provided at each further leg 15, 16 of the remaining plug-in parts 11, 12, in order to realize or to optimize a positive connection between the heat exchanger 3 and a plug-in part 11, 12. The plug-in parts 11, 12 additionally have internal support ribs 24, which are arranged on the legs 15, 16 within the respective leg plug-in receptacle 18 and on which the heat exchanger 3 is supported in the installed state of the plug-in parts 11, 12, see in particular FIG. 7

With reference to FIGS. 1 to 5, it is important to note that the lateral enclosures 5, 6 are furthermore characterized in an exemplary manner in that the plug-in parts 11 can each be locked or are each locked in a positive manner with the plug-in parts 12. For this purpose, the lateral enclosures 5, 6 or the first plug-in parts 11 and the second plug-in parts 12, respectively, each have an interface, which is referred to as first clip connection 30. The first clip connections 30 are each formed by means of a pair of locking protrusions 28, which is arranged on the second plug-in part 12, and a pair of locking receptacles 29, which is arranged on the first plug-in part 11 and which is formed in a complementary manner with respect to said locking protrusions 28. The pair of locking protrusions 28 and the pair of locking receptacles 29 can be locked or are locked with one another, so that a positive connection between a first plug-in part 11 and a second plug-in part 12 can be formed by means of the first clip connection 30. In the installed state of the heat exchanger assembly 1, see in particular FIGS. 1 and 5, the first clip connection 30 of the two lateral enclosures 5, 6, thus a respective pair of locking protrusions 28 and a pair of locking receptacles 29, are locked with one another, which can be accomplished, for example manually by hand or with tool during the installation. Compared to conventional solutions for holding comparable heat exchangers, this solution can be provided relatively cost-efficiently, is relatively compact, relatively lightweight as well as easy to install.

One said pair of locking protrusion 28 is advantageously inserted into a complementary pair of locking receptacles 29 in a joining direction 62, which runs in parallel with the X direction 47 and the secondary axis 61 and which is suggested by an arrow in FIG. 3, during the installation of the heat exchanger assembly 1. Locking lugs 31, which are arranged integrally on the respective locking protrusions 28 and which protrude orthogonally away from the respective locking protrusions 28, thereby each lock into position with a locking window 48 of a respective locking receptacle 29. Said first clip connections 30 are thus locked, whereby, as a result, a removal of the locking protrusions 28 from the locking receptacles 29 opposite to the joining direction 62, thus opposite to the X direction 47, is blocked. The first plug-in parts 11 are then locked in a positive manner with the second plug-in parts 12. It can also be provided that the locking of the plug-in parts 11, 12 by means of their locking protrusions 28 and locking receptacles 29 takes place simultaneously or as part of an operating step with the described caulking of the plug-in parts 11, 12 with the heat exchanger 3 in order to realize a positive connection.

It can be seen in particular in FIGS. 1 to 4 that the lateral enclosures 5, 6 or at least the first plug-in parts 11 and second plug-in parts 12 thereof each limit a passage 32 for one said connecting piece 33 of the heat exchanger 3. Viewed in the Z direction 47, such a passage 32 is advantageously arranged between the respective first plug-in parts 11 and second plug-in parts 12, and it is further advantageously designed so that it passes through the first clip connection 30 of the respective lateral enclosure 4, 5 in the X direction 44, whereby it is flanked on both sides in the Y direction 46 by locking protrusions 28 and locking receptacles 29 of the respective clip connection 30 of the respective lateral enclosure 4, 5. In FIG. 5, the passage 32 is simply hidden, so that the first clip connection 30 can be seen more easily there.

The lateral enclosures 5, 6 or the second plug-in parts 12, respectively, additionally have a further interface, which is referred to herein as second clip connection 34, which are made up of fixing part receptacles 63 arranged on the plug-in parts 12 and the mentioned fixing parts 13 of a lateral enclosure 4, 5. The fixing parts 13 and the respective second plug-in parts 12 can be locked easily with one another in a positive manner by means of the second clip connections 34, for example manually by hand, see in particular FIGS. 1 to 4 and 10 to 13. Advantageously, the fixing part 13 is a monolithic body and is equipped in particular on one end with a locking means 49 for the clip-on and locking of the fixing part 13 with said fixing part receptacle 63 of the second plug-in part 12, as well as, on the other end comprising a structural part interface 50 for fixing the fixing part 13 to said structural component 10 of the vehicle 2.

The fixing parts 13 are furthermore equipped in an exemplary manner with a tab-like catch lock 51, which can be deflected transverse to the secondary axis 61, comprising a locking window 66 and which can secure the respective fixing part 13 in an additionally described fixing position 39, against unintentional actuation in the direction of the secondary axis 61 by means of a complementary locking lug 65 of the second plug-in part 12. Said fixing part receptacles 63 are equipped in an exemplary manner with a retaining means 52 for a fixing part 13, which allows for a mobility of the fixing part 13 relative to the second plug-in part 12 in an initial position 38, but which prevents a complete detaching of the fixing part 13 from the second plug-in part 12 in the initial position 38, see in particular FIGS. 4 and 10. The retaining means 52 is realized herein by means of a ramp 37 or a ramp pair, which is oriented obliquely with respect to the secondary axis 61. It is thus possible to position a fixing part 13 on a plug-in part 12 as follows: Initially in the initial position 38, for example a bought-in configuration, in which a fixing part 13 is clipped onto a fixing part receptacle 63 of a plug-in part 12 by means of its locking means 49 in an attaching direction 67 (see FIG. 3), which is oriented transverse to the secondary axis 61 and to the joining direction 62, wherein the fixing part 13 is secured to the plug-in part 12, but is still mobile relative to the second plug-in part 12, for example in the direction of the secondary axis 61, see in particular FIG. 10. In a fixing position 39, in which the fixing part 13 is adjusted from the initial position 38 in an installation movement 64, which is suggested by an arrow in FIG. 10 and which runs parallel to the secondary axis 61, for example manually by hand, wherein the fixing part 13 is jammed to the second plug-in part 12 without play via said ramp 37.

The first plug-in parts 11 and/or the second plug-in parts 12 can furthermore be equipped with an internal spring element 42, which is in each case elastically tensioned onto the heat exchanger 3, see in particular FIG. 6.

1. A heat exchanger assembly (1) for a vehicle (2),
comprising a heat exchanger (3) and two lateral enclosures (4, 5), which hold said heat exchanger and which are arranged on opposite sides (7) of the heat exchanger (3) in order to each enclose a section (9) of a circumferential edge (8) of the heat exchanger (3) and which are configured to fix the heat exchanger assembly (1) to a structural component (10) of the vehicle (2), characterized in
that the lateral enclosures (4, 5) each have a first plug-in part (11), which is fixed in a positive manner to the heat exchanger (3), a second plug-in part (12), which is fixed in a positive manner to the heat exchanger (3), as well as a fixing part (13), which is arranged on the first plug-in part (11) and/or on the second plug-in part (12), for fixing the respective lateral enclosure (4, 5) to the structural component (10).

2. The heat exchanger assembly (1) according to claim 1, characterized in
that the first plug-in parts (11) can each be locked or are each locked in a positive manner with the second plug-in parts (12).

3. The heat exchanger assembly (1) according to claim 1 or 2, characterized in
that the first plug-in parts (11) and/or the second plug-in parts (12) are fixed in a positive manner to the heat exchanger (3) by means of caulking with the heat exchanger (3).

4. The heat exchanger assembly (1) according to one of the preceding claims, characterized by
at least one positive connection (14), which is formed by the respective first plug-in part (11) and/or the respective second plug-in part (12) and the heat exchanger (3) by means of caulking of a first plug-in part (11) and/or of a second plug-in part (12) with the heat exchanger (3),
wherein the respective positive connection (14) is characterized in that the respective first plug-in part (11), which is made of softer material with respect to the heat exchanger (3) and/or the respective second plug-in part (12), which is made of softer material with respect to the heat exchanger (3), is cut and/or partially peeled and/or plastically deformed by means of the heat exchanger (3), which is made of harder material, whereby the respective first plug-in part (11) and/or the respective second plug-in part (12) wedges or jams in a positive manner with the heat exchanger (3) detachably or non-detachably as well as without play.

5. The heat exchanger assembly (1) according to one of the preceding claims, characterized in
that the lateral enclosures (4, 5) are each of U-shaped design, and/or
that the first plug-in parts (11) and/or the second plug-in parts (12) are each of L-shaped design.

6. The heat exchanger assembly (1) according to one of the preceding claims, characterized in
that the first plug-in parts (11) and/or the second plug-in parts (12) each have two legs (15, 16), which are perpendicular to one another, each comprising a u-shaped leg cross section profile (17), and/or
that the two legs (15, 16) of a first plug-in part (11) and/or the two legs (15, 16) of a second plug-in part (12) form or limit a leg plug-in receptacle (18. 19), which is limited by the respective u-shaped leg cross section profile (17), wherein the leg plug-in receptacles (18, 19) of the two legs (15, 16) of a first plug-in part (11) and/or of a second plug-in part (12) optionally limit or form a common, cohesive plug-in part plug-in receptacle (20, 21) of the first plug-in part (11) and/or of the second plug-in part (12) for immersion of the heat exchanger (3), so that the first plug-in parts (11) and/or the second plug-in parts (12) can be attached to the heat exchanger (3) or are attached to the heat exchanger (3) in the installed state of the heat exchanger assembly (1).

7. The heat exchanger assembly (1) according to one of the preceding claims, characterized in
that at least a first plug-in part (11) and/or at least a second plug-in part (12) has positive ribs (25) for forming a positive connection (14), which is formed by the respective first plug-in part (11) and/or the respective second plug-in part (12) and the heat exchanger (3) by means of caulking the respective first plug-in part (11) and/or the respective second plug-in part (12) with the heat exchanger (3), and/or
that the positive ribs (25) are arranged on at least one leg (15, 16) of the two legs (15, 16) or on both legs (15, 16) of the respective first plug-in part (11) and/or of the respective second plug-in part (12) within the respective leg plug-in receptacle (18, 19), and are integrally connected to the respective leg (15, 16), and protrude into the respective leg plug-in receptacle (18, 19), and/or
that the positive ribs (25) are configured to be cut and/or peeled and/or plastically deformed by means of the heat exchanger (3) when attaching a respective plug-in part (11, 12) onto the heat exchanger (3), whereby the first plug-in part (11) and/or the second plug-in part (12) are wedged on the heat exchanger (3) detachably or non-detachably as well as without play.

8. The heat exchanger assembly (1) according to one of the preceding claims, characterized in
that the two lateral enclosures (4, 5) combined do not enclose the complete circumferential edge (8) of the heat exchanger (3), and/or
that the two lateral enclosures (4, 5) combined enclose at least 25% of the circumferential edge (8) of the heat exchanger (3), and/or
that the two lateral enclosures (4, 5) combined maximally enclose 50% of the circumferential edge (8) of the heat exchanger (3), and/or
that the lateral enclosures (4, 5) each completely enclose a section (9) of the heat exchanger (3), which is aligned vertically with respect to a ground, on which the vehicle (2) is parked, as well as each enclose at least 10% and maximally 20% of two sections (9), which are aligned horizontally with respect to the ground and which are arranged parallel to one another.

9. The heat exchanger assembly (1) according to one of the preceding claims, characterized in
that a pair of locking protrusions (28) is arranged on the first plug-in part (11), and a pair of locking receptacles (29), which is formed complementary with respect to said locking protrusions (28), is arranged on the second plug-in part (12), or vice versa, which can be locked or are locked with one another and form a first clip connection (30) for connecting the first plug-in parts (11) in a positive manner to the second plug-in parts (12), and/or
that, in the installed state of the heat exchanger assembly (1), at least one pair of locking protrusions (28) is locked into position with a pair of locking receptacles (29).

10. The heat exchanger assembly (1) according to one of the preceding claims, characterized in
that the lateral enclosures (4, 5) or the first plug-in parts (11) and/or the second plug-in parts (12) are fluid-tight and are arranged on the heat exchanger (3), optionally by means of an interconnected sealing means.

11. The heat exchanger assembly (1) according to one of the preceding claims, characterized in
that a passage (32) for a connecting piece (33) of the heat exchanger (3) is limited or formed at least between a first plug-in part (11) and a second plug-in part (12) of a lateral enclosure (4, 5), and/or
that said passage (32) passes through a first clip connection (30) of the respective lateral enclosure (4, 5), and/or
that said passage (32) is flanked on both sides by locking protrusions (28) and locking receptacles (29) of the respective lateral enclosure (4, 5).

12. The heat exchanger assembly (1) according to one of the preceding claims, characterized in
that the lateral enclosures (4, 5) or the first plug-in parts (11) and/or the second plug-in parts (12) and/or the fixing parts (13) are made of:
a plastic or a plastic composite material, or
a plastic, for example polypropylene (PP) or polyamide (PA), without glass fiber content, or
a plastic, for example polypropylene (PP) or polyamide (PA), with a glass fiber content, or
that the first plug-in parts (11) are made of polyamide (PA) with glass fiber content, and the second plug-in parts (12) of polypropylene (PP) with glass fiber content, or
that the first plug-in parts (11) are made of polypropylene (PP) with glass fiber content, and the second plug-in parts (12) of polyamide (PA) with glass fiber content, and/or
that the lateral enclosures (4, 5) or the first plug-in parts (11) and/or the second plug-in parts (12) and/or the fixing parts (13) are realized as hard or soft parts.

13. The heat exchanger assembly (1) according to one of the preceding claims, characterized in
that the first plug-in parts (11) or the second plug-in parts (12) have an interface, which is referred to as second clip connection (34), by means of which the fixing part (13) of a lateral enclosure (4, 5) and the respective first plug-in part (11) or the respective second plug-in part (12) can be locked or are locked with one another in a positive manner.

14. The heat exchanger assembly (1) according to one of the preceding claims, characterized in
that the first plug-in parts (11) are realized by means of identical parts, and/or
that the second plug-in parts (12) are realized by means of identical parts, or
that the first plug-in parts (11) and the second plug-in parts (12) are realized by means of identical parts, and/or
that at least one holder is soldered to the heat exchanger (3), by means of which at least one lateral enclosure (4, 5) can be fixed or is fixed to the heat exchanger (3).

15. A vehicle (2) comprising at least one installed heat exchanger assembly (1) according to the preceding claims, the heat exchanger (3) of which is realized by means of a coolant radiator or a condenser, wherein the at least one heat exchanger assembly (1) is fixed to a structural component (10) of the vehicle (2) by means of its lateral enclosures (4, 5).
